(19) United States
(12) Patent Application Publication
(10) Pub. No.: US 2022/0408670 A1
(43) Pub. Date: Dec. 29, 2022

(54) METHODS, SYSTEMS, APPARATUSES, AND DEVICES FOR FACILITATING PREPARING PLANTS FOR REGROWING THE PLANTS USING NUTRIENT FILM TECHNIQUE

(71) Applicant: Clean Acre Farms, LLC, San Juan Bautista, CA (US)

(72) Inventors: Vincent Brigantino, Hollister, CA (US); Siebe Streekstra, San Jose, CA (US)

(21) Appl. No.: 17/696,577

(22) Filed: Mar. 16, 2022

Related U.S. Application Data
(60) Provisional application No. 63/215,649, filed on Jun. 28, 2021.

(51) Int. Cl. A01G 31/04; A01G 24/44

(52) U.S. Cl. CPC A01G 31/042; A01G 24/44

(57) ABSTRACT

Disclosed herein is an apparatus for facilitating preparing plants for regrowing the plants using nutrient film technique, in accordance with some embodiments. Accordingly, the apparatus a conveyor, a harvesting device, a debris removing device, a microbiological control device, and a plant additive device. Further, the conveyor moves a plant through areas. Further, the harvesting device cuts a portion of the plant moved through a first area of the areas based on the moving. Further, the debris removing device removes debris attached to the plant moved through a second area of the areas after the cutting. Further, the microbiological control device removes harmful microorganism from the plant moved through a third area of the areas after the cleaning. Further, the plant additive device adds a plant health additive to the plant moved through a fourth area of the areas after the removing.

### FIELD OF THE INVENTION

Generally, the present disclosure relates to the field of plant husbandry. More specifically, the present disclosure relates to methods, systems, apparatuses, and devices for facilitating preparing plants for regrowing the plants using nutrient film technique.

### BACKGROUND OF THE INVENTION

Nutrient Film Technique (NFT) is a hydroponic growing technique used for growing plants such as lettuce, spinach, arugula, kale, mustards, chards, turnip greens, watercress, beet greens, herbs, etc. The NFT circulates a shallow stream of water, containing all the dissolved nutrients required for plant growth, past the bare roots of plants in water-tight channels or troughs. In most cases of the NFT in the industry, once the plants are harvested, the growing troughs are cleaned, and the process of seeding, germination, and harvest is started over again.

Therefore, there is a need for improved methods, systems, apparatuses, and devices for facilitating preparing plants for regrowing the plants using nutrient film technique that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating preparing plants for regrowing the plants using nutrient film technique, in accordance with some embodiments. Accordingly, the apparatus a conveyor, a harvesting device, a debris removing device, a microbiological control device, and a plant additive device. Further, the conveyor may be configured for moving at least one plant through a plurality of areas. Further, the harvesting device may be disposed in a first area of the plurality of areas. Further, the harvesting device may be configured for cutting at least a portion of the at least one plant moved through the first area based on the moving. Further, the debris removing device may be disposed in a second area of the plurality of areas. Further, the debris removing device may be configured for removing at least one debris attached to the at least one plant moved through the second area after the cutting. Further, the microbiological control device may be disposed in a third area of the plurality of areas. Further, the microbiological control device may be configured for removing at least one harmful microorganism from the at least one plant moved through the third area after the cleaning. Further, the plant additive device may be disposed in a fourth area of the plurality of areas. Further, the plant additive device may be configured for adding at least one plant health additive to the at least one plant moved through the fourth area after the removing.

Further disclosed herein is a method for facilitating preparing plants for regrowing the plants using nutrient film technique, in accordance with some embodiments. Accordingly, the method may include a step of moving, using a conveyor, at least one plant through a plurality of areas. Further, the method may include a step of cutting, using a harvesting device, at least a portion of the at least one plant moved based on the moving of the at least one plant through a first area of the plurality of areas. Further, the method may include a step of removing, using a debris removing device, at least one debris attached to the at least one plant moved through a second area of the plurality of areas after the cutting. Further, the method may include a step of removing, using a microbiological control device, at least one harmful microorganism from the at least one plant moved through a third area of the plurality of areas after the cleaning. Further, the method may include a step of adding, using a plant additive device, at least one plant health additive to the at least one plant moved through a fourth area of the plurality of areas after the removing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front perspective view of an apparatus for facilitating preparing plants for regrowing the plants using nutrient film technique, in accordance with some embodiments.

FIG. 2 is a front perspective view of the apparatus, in accordance with some embodiments.

FIG. 3 is a front perspective view of the apparatus, in accordance with some embodiments.

FIG. 4 is a front perspective view of the apparatus, in accordance with some embodiments.

FIG. 5 is a front perspective view of the apparatus, in accordance with some embodiments.

FIG. 6 is a front perspective view of the apparatus, in accordance with some embodiments.

FIG. 8 is a front perspective view of the apparatus, in accordance with some embodiments.

FIG. 9 is a front perspective view of the apparatus with a plurality of chambers of the apparatus, in accordance with some embodiments.

FIG. 10 is a front perspective view of an apparatus for facilitating preparing plants for regrowing the plants using nutrient film technique, in accordance with some embodiments.

FIG. 11 is a flowchart of a method for facilitating preparing plants for regrowing the plants using nutrient film technique, in accordance with some embodiments.

FIG. 12 is a flowchart of a method for facilitating the preparing of the plants for the regrowing of the plants using nutrient film technique, in accordance with some embodiments.

FIG. 13 is a flowchart of a method for facilitating the preparing of the plants for the regrowing of the plants using the nutrient film technique, in some embodiments.

FIG. 14 is a flowchart of a method for facilitating the preparing of the plants for the regrowing of the plants using the nutrient film technique, in accordance with some embodiments.

FIG. 15 is a flowchart of a method for facilitating the preparing of the plants for the regrowing of the plants using the nutrient film technique, in accordance with some embodiments.

FIG. 16 is a flowchart of a method for facilitating the preparing of the plants for the regrowing of the plants using the nutrient film technique, in accordance with some embodiments.

FIG. 17 is a flowchart of a method for facilitating preparing of plants for regrowing of the plants using nutrient film technique, in accordance with some embodiments.

FIG. 18 is an illustration of an online platform consistent with various embodiments of the present disclosure.

FIG. 19 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices preparing plants for regrowing the plants using nutrient film technique, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### OVERVIEW

The present disclosure describes methods, systems, apparatuses, and devices for facilitating preparing plants for regrowing the plants using nutrient film technique.

Further, the present disclosure describes an improved method and system for harvesting and regrowing plants. The disclosed apparatus and method may be applied to the NFT in the industry and allow the user to regrow the same plants for a second, third, or more harvests. The plants are harvested with an automated system and go through multiple treatments that will prepare the plants for the best possible post-harvest regrowth and supplemental harvest. The disclosed apparatus and method provides a cost advantage over other plant growing systems. Additional features and benefits are further discussed in the sections below.

Further, the present disclosure describes an improved method and system for harvesting and regrowing plants. In the NFT based growing systems in the industry, the plants are harvested for a single time and the harvested plants are wasted. However, in the present invention, the plants are harvested with improved methods and regrown with unique post-harvest treatments. The present invention drives crop yields up while reducing plant waste and the cost of regrowing new plants.

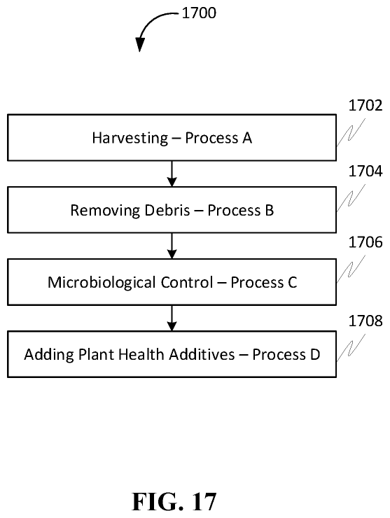

Further, the present disclosure describes multiple processes. The processes are automated systems, although some processes may be done manually. Further, the process includes harvesting (Process A), removing debris (Process B), microbiological control (Process C), and adding plant health additives (Process D) as shown in FIG. 17. Further, the processes may be done in a fully automated system. The plants to be harvested go through the process in the order of harvesting, removing debris, microbiological control using germicidal light treatment, microbiological control using microbial control agents, and adding plant health additives. The order in which the treatments are applied can vary. The fully grown plants are harvested utilizing a water jet, a band saw, a circular saw, a reciprocating saw, high pressure compressed air, or the like for the cleanest cut possible. In the preferred embodiment, the harvesting process is automated. The removing debris process is designed to adequately remove dead plant material such as leaves that have fallen on the harvested plants, media, or in the trough. The debris removal process can use any combination of air knives, vacuum, water sprays, hand labor, or other means to clean debris from the trough. Any remaining debris would be considered a defect if it were to be a part of the subsequent harvest. During the process of microbiological control using germicidal light treatment, harmful microbes are eliminated. In the preferred embodiment, the process utilizes UV light treatment, although any desired germicidal light treatment may be used. The treatment could be used either immediately before harvest, immediately after harvest, or both. The goal of the process is to control plant and human pathogens and other microbes. During the process of microbiological control using microbial control agents, microbial control agents including, but not limited to, hydrogen peroxide, peracetic acid, ozone, and fungicides are introduced to the post-harvest area. The microbial control agents can be delivered via water sprays, waterfalls, micro mists, foggers, or other means. The adding plant health additives process is designed to add plant nutrients, beneficial microbes, and other items to improve plant health and promote regrowth. The nutrients and health additives could be delivered via water sprays, waterfalls, micro mists, foggers, or other means. The order in which the treatments are administered can vary. For example, microbiological control (Process C) can be applied prior to debris removal (Process B) along with all other order variations. Additionally, it is not necessary to do all treatments. Any post-harvest treatment standing alone will enhance regrowth. For example, simply doing Process B on its own will enhance regrowth. Completing Processes B and C in any order becomes more effective and completing Processes B, C, and D in any order becomes the most effective for post-harvest regrowth.

Further, the present disclosure relates generally to a method for plant regrowth preparation. More specifically, the present disclosure describes a method and system for preparing the regrowth of harvested plants.

Further, the present disclosure describes post-harvest regrowth preparation in the nutrient film technique method and system.

Further, the disclosed apparatus may include a trough assembly line, at least one plant, a harvesting tool, a debris-removing device, a microbiological control device, a plant additive device. Further, the harvesting tool may include a water jet, band saw, circular saw, reciprocating saw, high pressure compressed air. Further, the debris-removing device may include a specialized area or chamber for removing debris which may include air knives, a vacuum, water sprays, etc. Further, the microbiological control device may include a specialized area or chamber for microbiological control which may include at least one UV light device. Further, the microbiological control device may include a specialized area or chamber for further microbiological control which may use hydrogen peroxide, peracetic acid, ozone, and/or fungicides—these can be delivered via water sprays, waterfalls, micro mists, foggers, etc. Further, the plant additive device may include a specialized area or chamber to add plant additives which may be plant nutrients, beneficial microbes—these can be delivered via water sprays, waterfalls, micro mists, foggers, etc.

Further, the disclosed method may include steps such as harvesting the plants, removing debris from the plants, microbiological control using germicidal light treatment, which could be done before the harvesting of the plants or after removing debris from the plants, microbiological control using microbial control agents and adding plant health additives.

Further, the present disclosure describes a regrowth method specifically designed for trough based indoor growing system.

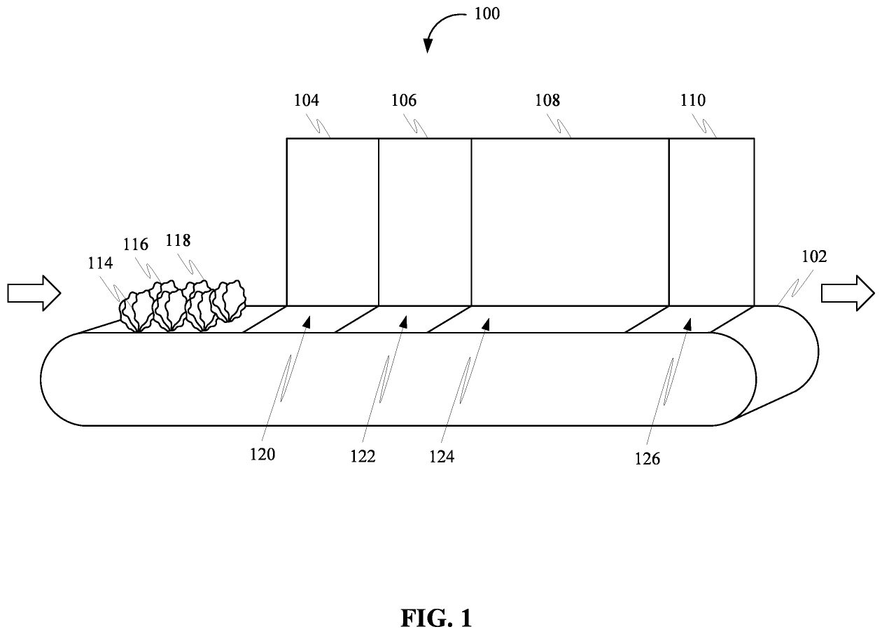

FIG. 1 is a front perspective view of an apparatus 100 for facilitating preparing plants for regrowing the plants using nutrient film technique, in accordance with some embodiments. Accordingly, the apparatus 100 may include a conveyor 102, a harvesting device 104, a debris removing device 106, a microbiological control device 108, and a plant additive device 110.

Further, the conveyor 102 may be configured for moving at least one plant 114-118 through a plurality of areas 120-126. Further, the conveyor 102 may include a trough assembly line. Further, the conveyor 102 may move the at least one plant 114-118 along a work path for the preparing of the at least one plant 114-118.

Further, the harvesting device 104 may be disposed in a first area 120 of the plurality of areas 120-126. Further, the harvesting device 104 may be configured for cutting at least a portion of the at least one plant 114-118 moved through the first area 120 based on the moving. Further, the harvesting device 104 may include a harvesting tool. Further, the harvesting tool may include a water jet, a band saw, a circular saw, a reciprocating saw, a high pressure compressed air, etc.

Further, the debris removing device 106 may be disposed in a second area 122 of the plurality of areas 120-126. Further, the debris removing device 106 may be configured for removing at least one debris attached to the at least one plant 114-118 moved through the second area 122 after the cutting. Further, the debris removing device 106 air knives, vacuum suctions, water sprays, etc.

Further, the microbiological control device 108 may be disposed in a third area 124 of the plurality of areas 120-126. Further, the microbiological control device 108 may be configured for removing at least one harmful microorganism from the at least one plant 114-118 moved through the third area 124 after the cleaning.

Further, the plant additive device 110 may be disposed in a fourth area 126 of the plurality of areas 120-126. Further, the plant additive device 110 may be configured for adding at least one plant health additive to the at least one plant 114-118 moved through the fourth area 126 after the removing. Further, the at least one plant health additive may include plant nutrients, beneficial microbes, etc.

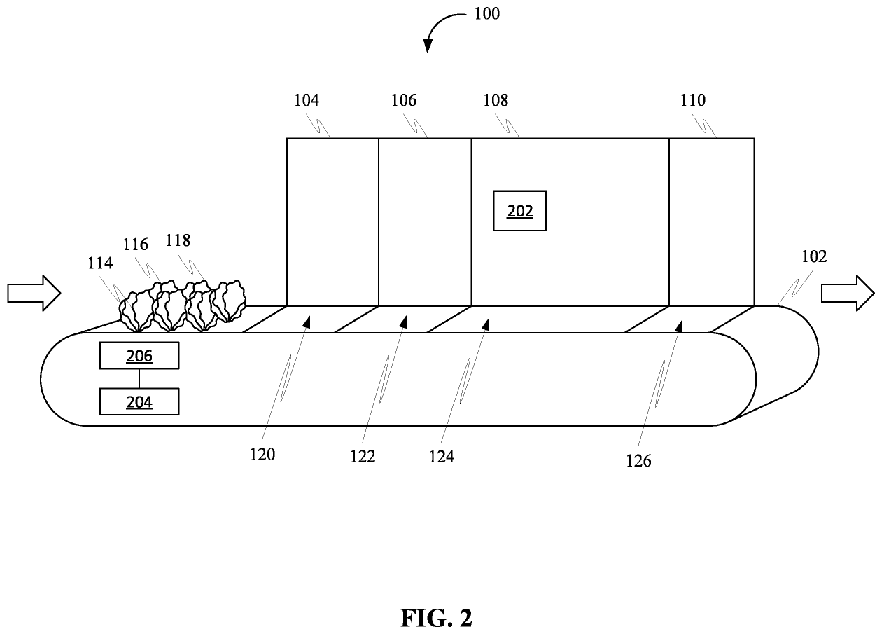

Further, in some embodiments, the microbiological control device 108 may include an irradiating device 202, as shown in FIG. 2. Further, the irradiating device 202 may be configured for irradiating the at least one plant 114-118 using at least one germicidal light of at least one germicidal light characteristic. Further, the removing of the at least one harmful microorganism from the at least one plant 114-118 may be based on the irradiating. Further, the irradiating device 202 may include an ultraviolet light device. Further, the at least one germicidal light may include ultraviolet light. Further, the ultraviolet light may include ultraviolet light A, ultraviolet light B, ultraviolet light C, etc. Further, the at least one germicidal light characteristic may include an intensity, a polarization, etc.

In further embodiments, the apparatus 100 may include at least one biological sensor 206 and a processing device 204, as shown in FIG. 2. Further, the at least one biological sensor 206 may be configured for generating at least one biological data based on detecting the at least one harmful microorganism present on the at least one plant 114-118. Further, the at least one harmful microorganism may include viruses, bacteria, fungi, etc that are harmful to the at least one plant 114-118. Further, the processing device 204 may be communicatively coupled with the at least one biological sensor 206. Further, the processing device 204 may be configured for analyzing the at least one biological data. Further, the processing device 204 may be configured for determining at least one of a type and a concentration of the at least one harmful microorganism present on the at least one plant 114-118 based on the analyzing of the at least one biological data. Further, the processing device 204 may be configured for identifying the at least one germicidal light and the at least one germicidal light characteristic of the at least one germicidal light based on the determining of at least one of the type and the concentration of the at least one harmful microorganism. Further, the processing device 204 may be configured for generating at least one second command for the irradiation of the at least one plant 114-118 based on the identifying. Further, the processing device 204 may be communicatively coupled with the irradiating device 202. Further, the irradiating of the at least one plant 114-118 using the at least one germicidal light of the at least one germicidal light characteristic may be based on the at least one second command.

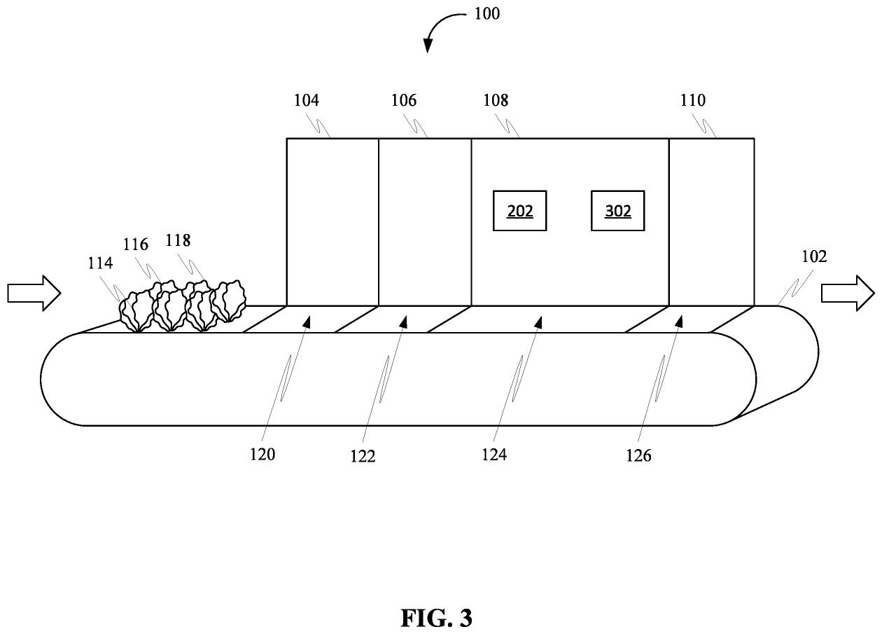

Further, in some embodiments, the microbiological control device 108 may include a microbial agent applicator 302, as shown in FIG. 3. Further, the microbial agent applicator 302 may be configured for applying at least one microbial control agent to the at least one plant 114-118 using at least one application method. Further, the removing of the at least one harmful microorganism from the at least one plant 114-118 may be based on the applying. Further, the at least one microbial control agent may include hydrogen peroxide, peracetic acid, ozone, fungicides, etc. Further, the at least one application method may include water spraying, waterfalling, micro misting, fogging, etc.

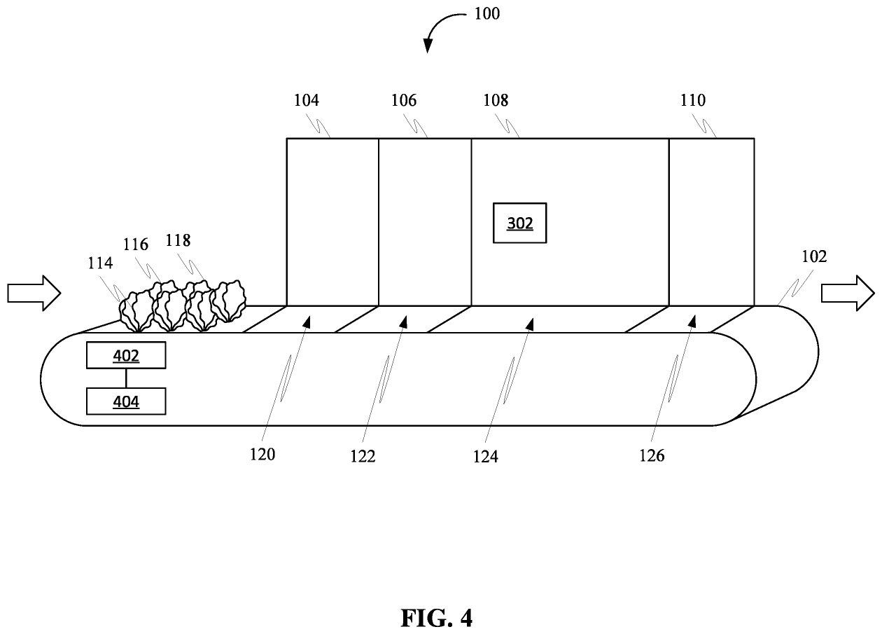

In further embodiments, the apparatus 100 may include at least one first biological sensor 402 and a processing device 404, as shown in FIG. 4. Further, the at least one first biological sensor 402 may be configured for generating at least one first biological data based on detecting the at least one harmful microorganism present on the at least one plant 114-118. Further, the at least one harmful microorganism may include viruses, bacteria, fungi, etc that are harmful to the at least one plant 114-118. Further, the processing device 404 may be communicatively coupled with the at least one first biological sensor 402. Further, the processing device 404 may be configured for analyzing the at least one first biological data. Further, the processing device 404 may be configured for determining at least one of a type and a concentration of the at least one harmful microorganism present on the at least one plant 114-118 based on the analyzing of the at least one biological data. Further, the processing device 404 may be configured for identifying the at least one microbial control agent and the at least one application method based on the determining of at least one of the type and the concentration of the at least one harmful microorganism. Further, the processing device 404 may be configured for generating at least one third command for the applying of the at least one microbial control agent to the at least one plant 114-118 using the at least one application method based on the identifying. Further, the processing device 404 may be communicatively coupled with the microbial agent applicator 302. Further, the applying of the at least one microbial control agent to the at least one plant 114-118 using the at least one application method may be based on the at least one third command.

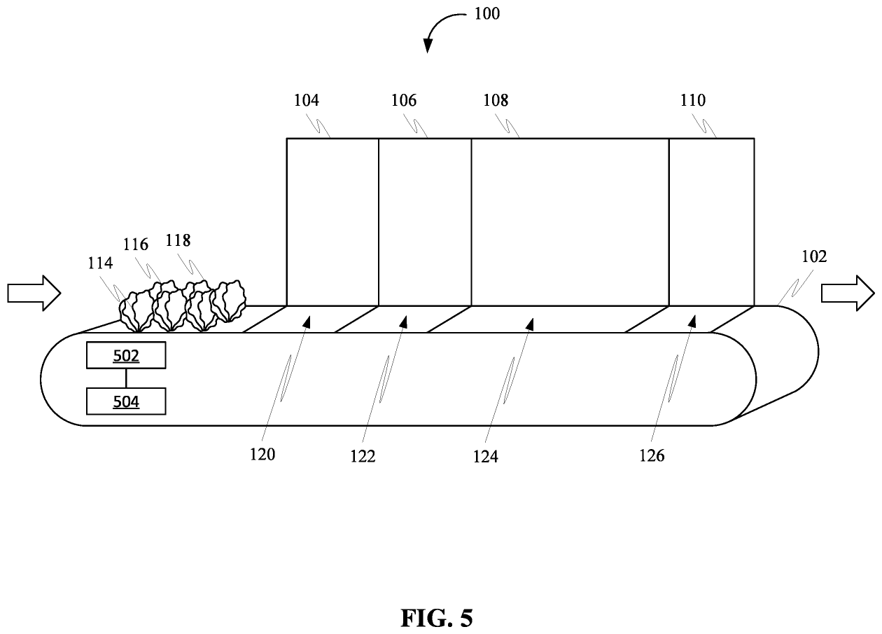

In further embodiments, the apparatus 100 may include at least one sensor 502 and a processing device 504, as shown in FIG. 5. Further, the at least one sensor 502 may be configured for generating at least one sensor data associated with the at least one plant 114-118 based on detecting at least one plant characteristic of the at least one plant 114-118. Further, the at least one plant characteristic a structure, a texture, a pigmentation, a color, etc. of at least the portion of the at least one plant 114-118. Further, the processing device 504 may be communicatively coupled with the at least one sensor 502. Further, the processing device 504 may be configured for analyzing the at least one sensor data using at least one machine learning model. Further, the processing device 504 may be configured for identifying at least the portion of the at least one plant 114-118 based on the analyzing. Further, the processing device 504 may be configured for generating at least one command for the cutting of at least the portion of the at least one plant 114-118 based on the identifying. Further, the harvesting device 104 may be communicatively coupled with the processing device 504. Further, the cutting of at least the portion of the at least one plant 114-118 may be based on the at least one command.

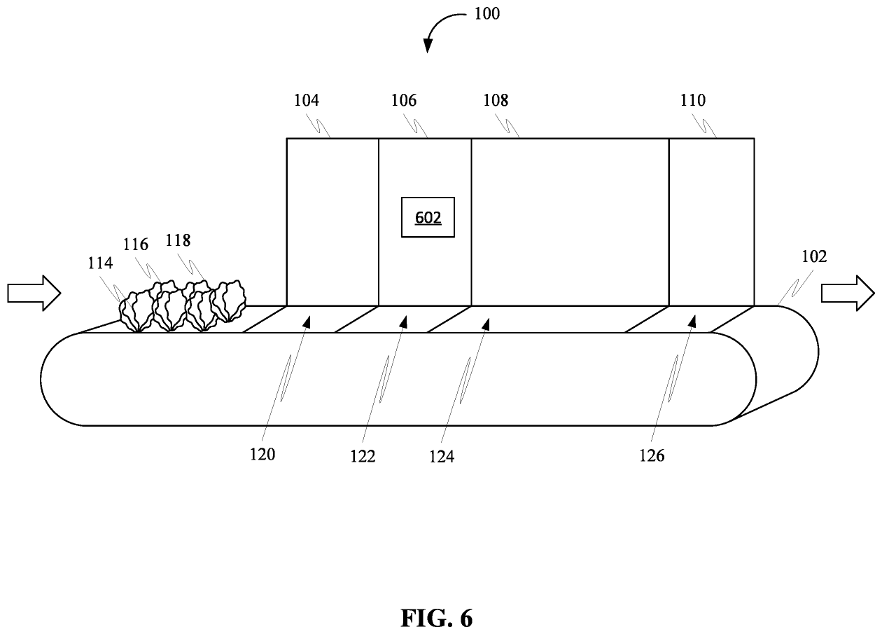

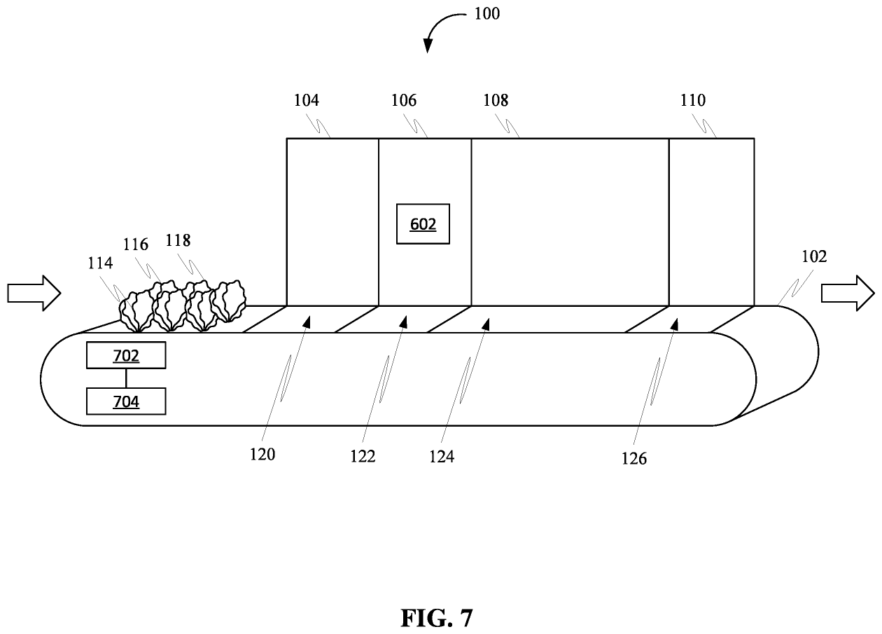

Further, in some embodiments, the debris removing device 106 may include at least one fluid ejecting device 602, as shown in FIG. 6. Further, the at least one fluid ejecting device 602 may be configured for ejecting at least one fluid of at least one fluid characteristic on the at least one plant 114-118. Further, the removing of the at least one debris attached to the at least one plant 114-118 may be further based on the ejecting. Further, the at least one fluid ejecting device 602 may include a water spray, an air knife, etc. Further, the at least one fluid characteristic may include a flow rate, a velocity, a pressure, a temperature, etc.

In further embodiments, the apparatus 100 may include at least one first sensor 702 and a processing device 704, as shown in FIG. 7. Further, the at least one first sensor 702 may be configured for generating at least one first sensor data associated with the at least one plant 114-118 based on detecting at least one first plant characteristic of the at least one plant 114-118. Further, the at least one first plant characteristic a structure, a texture, etc. Further, the processing device 704 may be communicatively coupled with the at least one first sensor 702. Further, the processing device 704 may be configured for analyzing the at least one first sensor data using at least one first machine learning model. Further, the processing device 704 may be configured for determining a classification from a plurality of classifications for the at least one plant 114-118 based on the analyzing of the at least one sensor data. Further, the plurality of classifications may include a weak plant, a strong plant, a hydrophobic plant, etc. Further, the processing device 704 may be configured for determining the at least one fluid and the at least one fluid characteristic of the at least one fluid based on the determining of the classification. Further, the processing device 704 may be configured for generating at least one first command based on the determining of the at least one fluid and the at least one fluid characteristic. Further, the at least one fluid ejecting device 602 may be communicatively coupled with the processing device 704. Further, the ejecting of the at least one fluid of the at least one fluid characteristic on the at least one plant 114-118 may be based on the at least one first command.

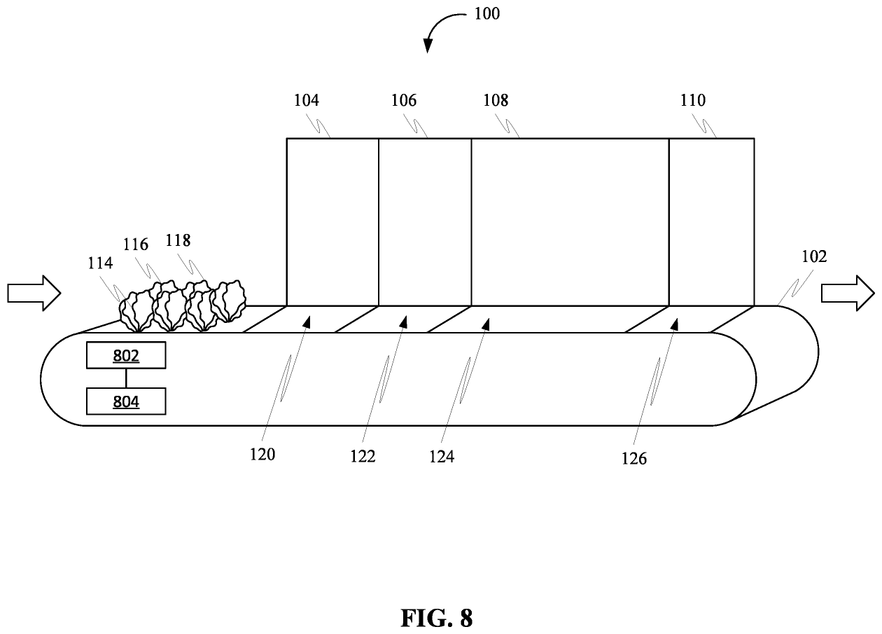

In further embodiments, the apparatus 100 may include at least one second sensor 802 and a processing device 804, as shown in FIG. 8. Further, the at least one second sensor 802 may be configured for generating at least one second sensor data based on detecting at least one second plant characteristic of the at least one plant 114-118. Further, the at least one second plant characteristic may include movement, nutrition, respiration, sensitivity, reproduction, excretion, growth, etc. Further, the processing device 804 may be communicatively coupled with the at least one second sensor 802. Further, the processing device 804 may be configured for analyzing the at least one second sensor data using at least one second machine learning model. Further, the processing device 804 may be configured for determining a requirement of the at least one plant 114-118 for the at least one plant health additive based on the analyzing of the at least one second sensor data. Further, the requirement may include a type and a quantity of the at least one plant health additive. Further, the processing device 804 may be configured for generating at least one fourth command for the adding of the at least one plant health additive to the at least one plant 114-118 based on the determining of the requirement. Further, the plant additive device 110 may be communicatively coupled with the processing device 804. Further, the adding of the at least one plant health additive to the at least one plant 114-118 may be based on the at least one fourth command.

FIG. 2 is a front perspective view of the apparatus 100, in accordance with some embodiments.

FIG. 3 is a front perspective view of the apparatus 100, in accordance with some embodiments.

FIG. 4 is a front perspective view of the apparatus 100, in accordance with some embodiments.

FIG. 5 is a front perspective view of the apparatus 100, in accordance with some embodiments.

FIG. 6 is a front perspective view of the apparatus 100, in accordance with some embodiments.

FIG. 8 is a front perspective view of the apparatus 100, in accordance with some embodiments.

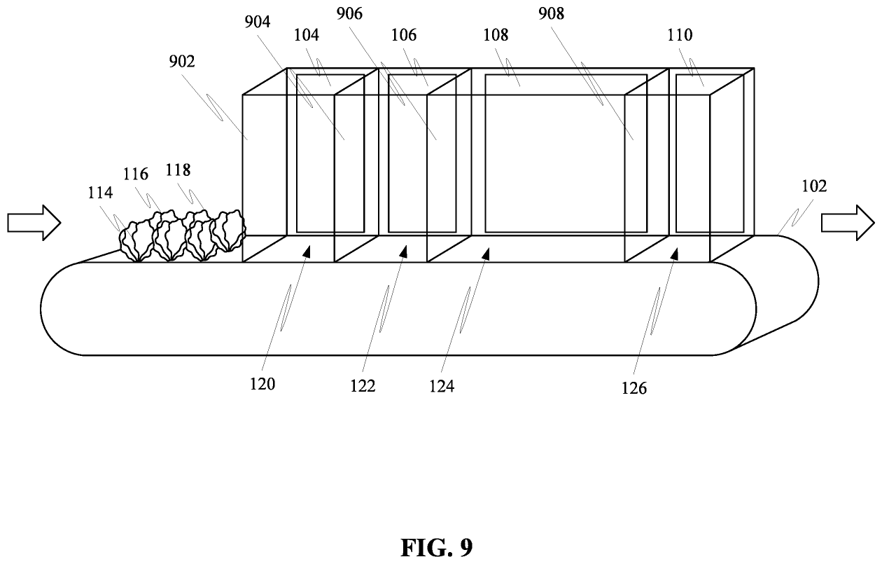

FIG. 9 is a front perspective view of the apparatus 100 with a plurality of chambers 902-908 of the apparatus 100, in accordance with some embodiments. Further, the plurality of chambers 902-908 defines the plurality of areas 120-126.

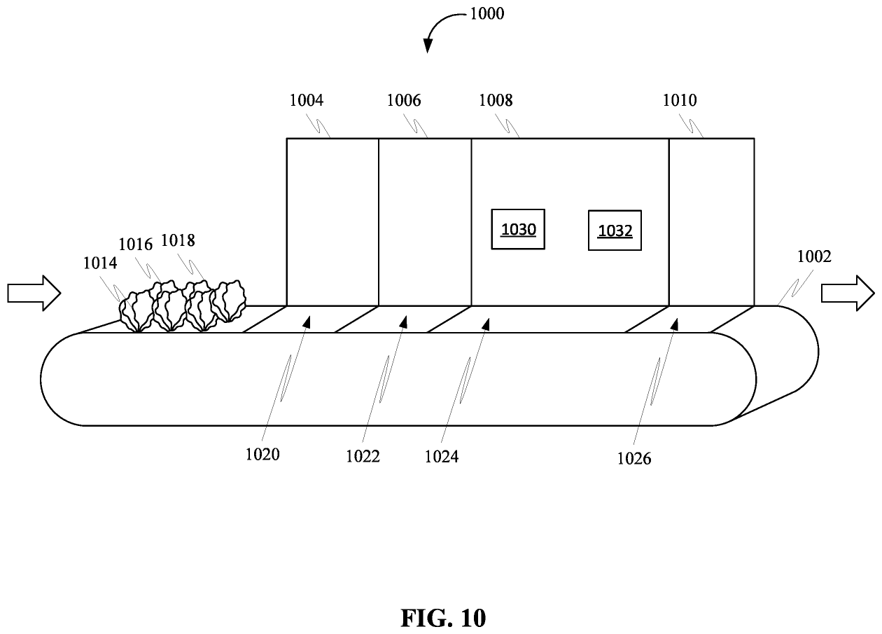

FIG. 10 is a front perspective view of an apparatus 1000 for facilitating preparing plants for regrowing the plants using nutrient film technique, in accordance with some embodiments. Further, the apparatus 1000 may include a conveyor 1002, a harvesting device 1004, a debris removing device 1006, a microbiological control device 1008, and a plant additive device 1010.

Further, the conveyor 1002 may be configured for moving at least one plant 1014-1018 through a plurality of areas 1020-1026.

Further, the harvesting device 1004 may be disposed in a first area 1020 of the plurality of areas 1020-1026. Further, the harvesting device 1004 may be configured for cutting at least a portion of the at least one plant 1014-1018 moved through the first area 1020 based on the moving.

Further, the debris removing device 1006 may be disposed in a second area 1022 of the plurality of areas 1020-1026. Further, the debris removing device 1006 may be configured for removing at least one debris attached to the at least one plant 1014-1018 moved through the second area 1022 after the cutting.

Further, the microbiological control device 1008 may be disposed in a third area 1024 of the plurality of areas 1020-1026. Further, the microbiological control device 1008 may be configured for removing at least one harmful microorganism from the at least one plant 1014-1018 moved through the third area 1024 after the cleaning. Further, the microbiological control device 1008 further may include an irradiating device 1030. Further, the irradiating device 1030 may be configured for irradiating the at least one plant 1014-1018 using at least one germicidal light of at least one germicidal light characteristic. Further, the removing of the at least one harmful microorganism from the at least one plant 1014-1018 may be further based on the irradiating.

Further, the plant additive device 1010 may be disposed in a fourth area 1026 of the plurality of areas 1020-1026. Further, the plant additive device 1010 may be configured for adding at least one plant health additive to the at least one plant 1014-1018 moved through the fourth area 1026 after the removing.

Further, in some embodiments, the microbiological control device 1008 further may include a microbial agent applicator 1032. Further, the microbial agent applicator 1032 may be configured for applying at least one microbial control agent to the at least one plant 1014-1018 using at least one application method. Further, the removing of the at least one harmful microorganism from the at least one plant 1014-1018 may be further based on the applying.

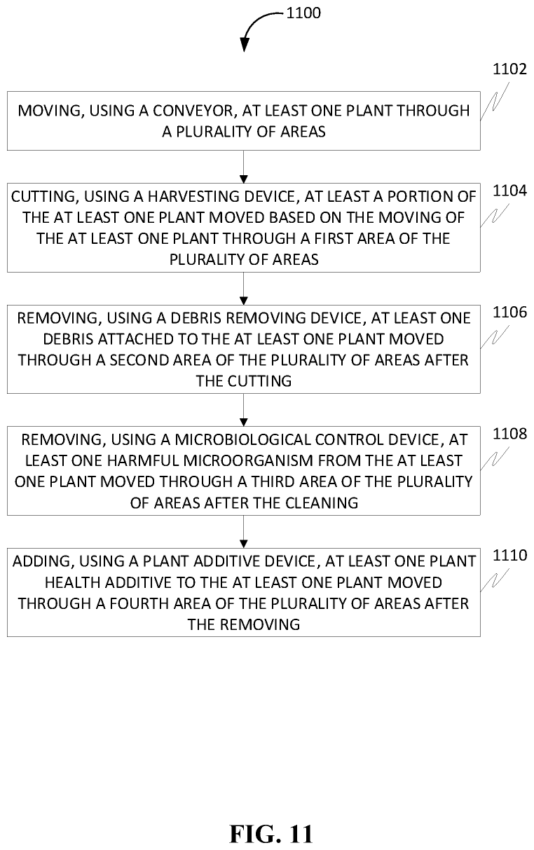

FIG. 11 is a flowchart of a method 1100 for facilitating preparing plants for regrowing the plants using nutrient film technique, in accordance with some embodiments. Accordingly, the method 1100 may include a step 1102 of moving, using a conveyor, at least one plant through a plurality of areas.

Further, the method 1100 may include a step 1104 of cutting, using a harvesting device, at least a portion of the at least one plant moved based on the moving of the at least one plant through a first area of the plurality of areas.

Further, the method 1100 may include a step 1106 of removing, using a debris removing device, at least one debris attached to the at least one plant moved through a second area of the plurality of areas after the cutting.

Further, the method 1100 may include a step 1108 of removing, using a microbiological control device, at least one harmful microorganism from the at least one plant moved through a third area of the plurality of areas after the cleaning.

Further, the method 1100 may include a step 1110 of adding, using a plant additive device, at least one plant health additive to the at least one plant moved through a fourth area of the plurality of areas after the removing.

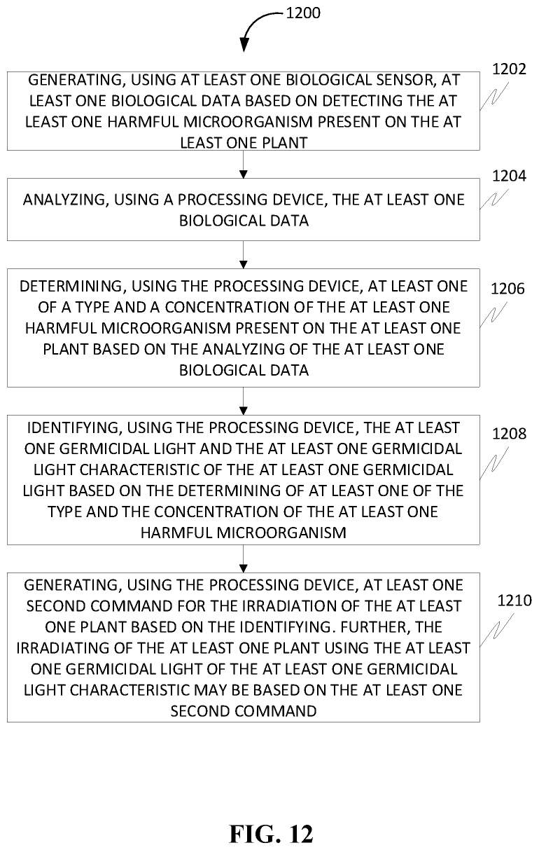

FIG. 12 is a flowchart of a method 1200 for facilitating the preparing of the plants for the regrowing of the plants using nutrient film technique, in accordance with some embodiments. Further, the microbiological control device may include an irradiating device. Further, the irradiating device may be configured for irradiating the at least one plant using at least one germicidal light of at least one germicidal light characteristic. Further, the removing of the at least one harmful microorganism from the at least one plant may be further based on the irradiating.

Further, the method 1200 may include a step 1202 of generating, using at least one biological sensor, at least one biological data based on detecting the at least one harmful microorganism present on the at least one plant.

Further, the method 1200 may include a step 1204 of analyzing, using a processing device, the at least one biological data.

Further, the method 1200 may include a step 1206 of determining, using the processing device, at least one of a type and a concentration of the at least one harmful microorganism present on the at least one plant based on the analyzing of the at least one biological data.

Further, the method 1200 may include a step 1208 of identifying, using the processing device, the at least one germicidal light and the at least one germicidal light characteristic of the at least one germicidal light based on the determining of at least one of the type and the concentration of the at least one harmful microorganism.

Further, the method 1200 may include a step 1210 of generating, using the processing device, at least one second command for the irradiation of the at least one plant based on the identifying. Further, the processing device may be communicatively coupled with the irradiating device. Further, the irradiating of the at least one plant using the at least one germicidal light of the at least one germicidal light characteristic may be based on the at least one second command.

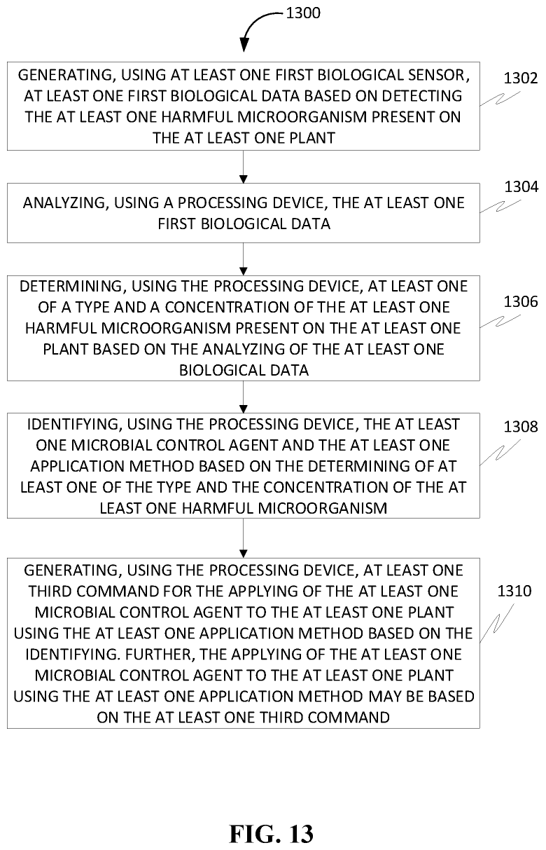

FIG. 13 is a flowchart of a method 1300 for facilitating the preparing of the plants for the regrowing of the plants using the nutrient film technique, in some embodiments. Further, the microbiological control device further may include a microbial agent applicator. Further, the microbial agent applicator may be configured for applying at least one microbial control agent to the at least one plant using at least one application method. Further, the removing of the at least one harmful microorganism from the at least one plant may be further based on the applying. Further, the method 1300 may include a step 1302 of generating, using at least one first biological sensor, at least one first biological data based on detecting the at least one harmful microorganism present on the at least one plant.

Further, the method 1300 may include a step 1304 of analyzing, using a processing device, the at least one first biological data.

Further, the method 1300 may include a step 1306 of determining, using the processing device, at least one of a type and a concentration of the at least one harmful microorganism present on the at least one plant based on the analyzing of the at least one biological data.

Further, the method 1300 may include a step 1308 of identifying, using the processing device, the at least one microbial control agent and the at least one application method based on the determining of at least one of the type and the concentration of the at least one harmful microorganism.

Further, the method 1300 may include a step 1310 of generating, using the processing device, at least one third command for the applying of the at least one microbial control agent to the at least one plant using the at least one application method based on the identifying. Further, the processing device may be communicatively coupled with the microbial agent applicator. Further, the applying of the at least one microbial control agent to the at least one plant using the at least one application method may be based on the at least one third command.

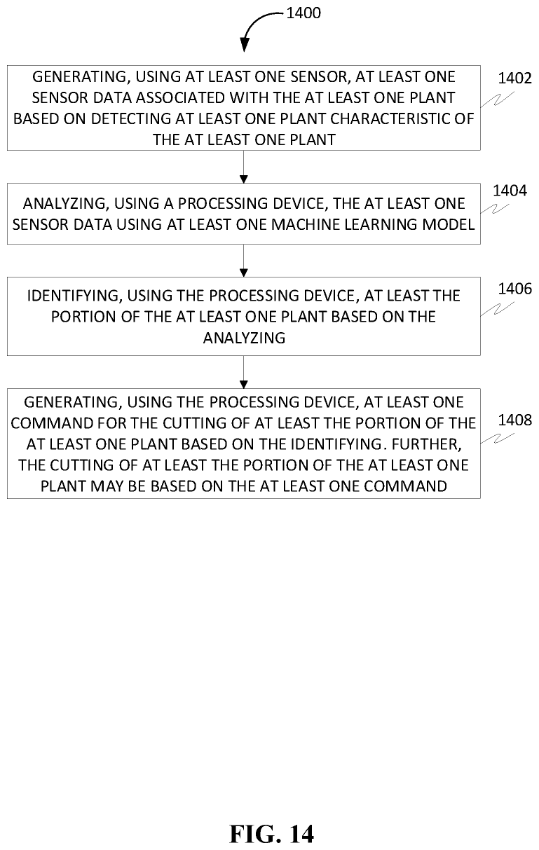

FIG. 14 is a flowchart of a method 1400 for facilitating the preparing of the plants for the regrowing of the plants using the nutrient film technique, in accordance with some embodiments. Accordingly, the method 1400 may include a step 1402 of generating, using at least one sensor, at least one sensor data associated with the at least one plant based on detecting at least one plant characteristic of the at least one plant.

Further, the method 1400 may include a step 1404 of analyzing, using a processing device, the at least one sensor data using at least one machine learning model.

Further, the method 1400 may include a step 1406 of identifying, using the processing device, at least the portion of the at least one plant based on the analyzing.

Further, the method 1400 may include a step 1408 of generating, using the processing device, at least one command for the cutting of at least the portion of the at least one plant based on the identifying. Further, the harvesting device may be communicatively coupled with the processing device. Further, the cutting of at least the portion of the at least one plant may be based on the at least one command.

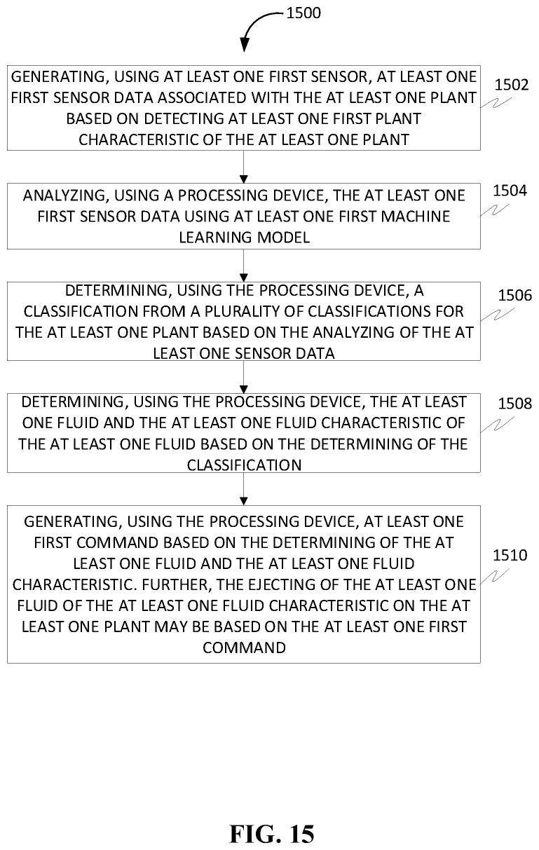

FIG. 15 is a flowchart of a method 1500 for facilitating the preparing of the plants for the regrowing of the plants using the nutrient film technique, in accordance with some embodiments. Further, the debris removing device may include at least one fluid ejecting device. Further, the at least one fluid ejecting device may be configured for ejecting at least one fluid of at least one fluid characteristic on the at least one plant. Further, the removing of the at least one debris attached to the at least one plant may be further based on the ejecting. Further, the method 1500 may include a step 1502 of generating, using at least one first sensor, at least one first sensor data associated with the at least one plant based on detecting at least one first plant characteristic of the at least one plant.

Further, the method 1500 may include a step 1504 of analyzing, using a processing device, the at least one first sensor data using at least one first machine learning model.

Further, the method 1500 may include a step 1506 of determining, using the processing device, a classification from a plurality of classifications for the at least one plant based on the analyzing of the at least one sensor data.

Further, the method 1500 may include a step 1508 of determining, using the processing device, the at least one fluid and the at least one fluid characteristic of the at least one fluid based on the determining of the classification.

Further, the method 1500 may include a step 1510 of generating, using the processing device, at least one first command based on the determining of the at least one fluid and the at least one fluid characteristic. Further, the at least one fluid ejecting device may be communicatively coupled with the processing device. Further, the ejecting of the at least one fluid of the at least one fluid characteristic on the at least one plant may be based on the at least one first command.

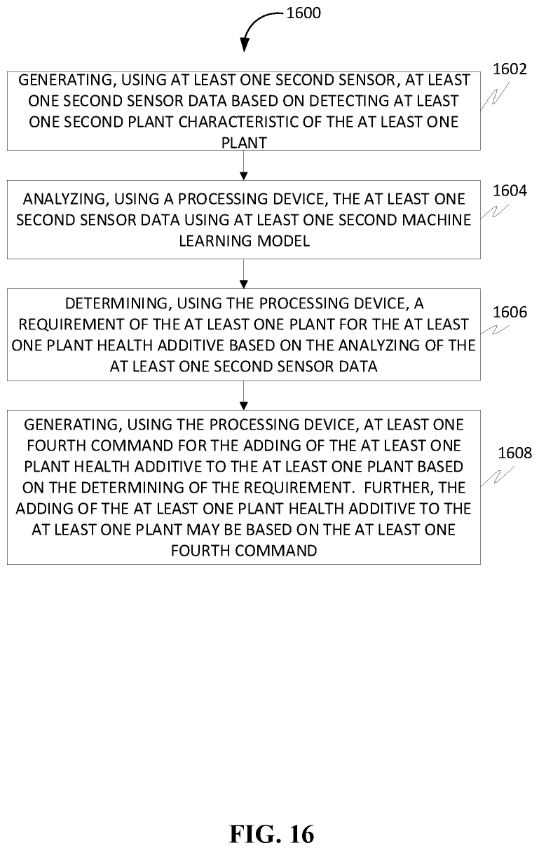

FIG. 16 is a flowchart of a method 1600 for facilitating the preparing of the plants for the regrowing of the plants using the nutrient film technique, in accordance with some embodiments. Further, the method 1600 may include a step 1602 of generating, using at least one second sensor, at least one second sensor data based on detecting at least one second plant characteristic of the at least one plant.

Further, the method 1600 may include a step 1604 of analyzing, using a processing device, the at least one second sensor data using at least one second machine learning model.

Further, the method 1600 may include a step 1606 of determining, using the processing device, a requirement of the at least one plant for the at least one plant health additive based on the analyzing of the at least one second sensor data.

Further, the method 1600 may include a step 1608 of generating, using the processing device, at least one fourth command for the adding of the at least one plant health additive to the at least one plant based on the determining of the requirement. Further, the plant additive device may be communicatively coupled with the processing device. Further, the adding of the at least one plant health additive to the at least one plant may be based on the at least one fourth command.

FIG. 17 is a flowchart of a method 1700 for facilitating preparing of plants for regrowing of the plants using nutrient film technique, in accordance with some embodiments. Further, the method 1700 may include a step 1702 of harvesting a plant. Further, the harvesting may be Process A.

Further, the method 1700 may include a step 1704 of removing debris from the plant. Further, the removing debris may be Process B.

Further, the method 1700 may include a step 1706 of microbiological control to the plant. Further, the microbiological control may be Process C.

Further, the method 1700 may include a step 1708 of adding plant health additives to the plant. Further, the adding may be Process D.

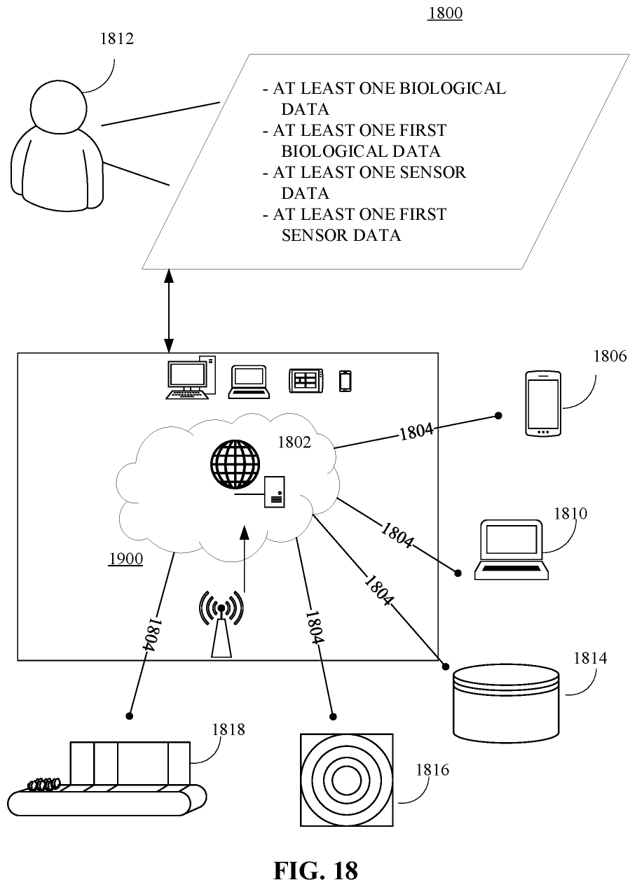

FIG. 18 is an illustration of an online platform 1800 consistent with various embodiments of the present disclosure. By way of non-limiting example, the online platform 1800 to facilitate preparing plants for regrowing the plants using nutrient film technique may be hosted on a centralized server 1802, such as, for example, a cloud computing service. The centralized server 1802 may communicate with other network entities, such as, for example, a mobile device 1806 (such as a smartphone, a laptop, a tablet computer etc.), other electronic devices 1810 (such as desktop computers, server computers etc.), databases 1814, sensors 1816, an apparatus 1818 (such as the apparatus 100, the apparatus 1000, etc.) over a communication network 1804, such as, but not limited to, the Internet. Further, users of the online platform 1800 may include relevant parties such as, but not limited to, end-users, users, administrators, service providers, service consumers, and so on. Accordingly, in some instances, electronic devices operated by the one or more relevant parties may be in communication with the platform.

A user 1812, such as the one or more relevant parties, may access online platform 1800 through a web based software application or browser. The web based software application may be embodied as, for example, but not be limited to, a website, a web application, a desktop application, and a mobile application compatible with a computing device 1900.

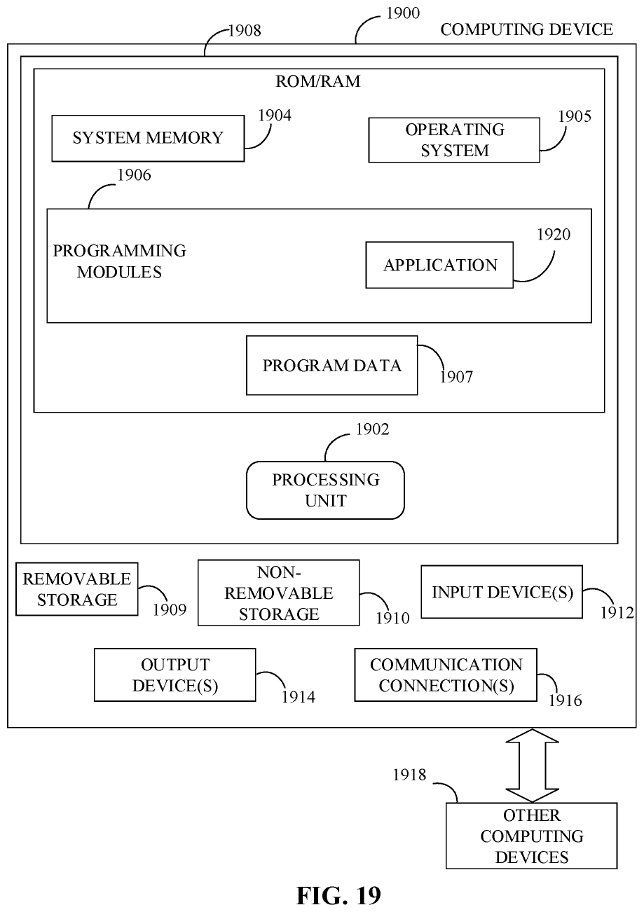

With reference to FIG. 19, a system consistent with an embodiment of the disclosure may include a computing device or cloud service, such as computing device 1900. In a basic configuration, computing device 1900 may include at least one processing unit 1902 and a system memory 1904. Depending on the configuration and type of computing device, system memory 1904 may comprise, but is not limited to, volatile (e.g. random-access memory (RAM)), non-volatile (e.g. read-only memory (ROM)), flash memory, or any combination. System memory 1904 may include operating system 1905, one or more programming modules 1906, and may include a program data 1907. Operating system 1905, for example, may be suitable for controlling computing device 1900's operation. In one embodiment, programming modules 1906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 19 by those components within a dashed line 1908.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by a removable storage 1909 and a non-removable storage 1910. Computer storage media may include volatile and non-volatile, removable and non-removable media implemented in any method or technology for storage of information, such as computer-readable instructions, data structures, program modules, or other data. System memory 1904, removable storage 1909, and non-removable storage 1910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1900. Any such computer storage media may be part of device 1900. Computing device 1900 may also have input device(s) 1912 such as a keyboard, a mouse, a pen, a sound input device, a touch input device, a location sensor, a camera, a biometric sensor, etc. Output device(s) 1914 such as a display, speakers, a printer, etc. may also be included. The aforementioned devices are examples and others may be used.

Computing device 1900 may also contain a communication connection 1916 that may allow device 1900 to communicate with other computing devices 1918, such as over a network in a distributed computing environment, for example, an intranet or the Internet. Communication connection 1916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1904, including operating system 1905. While executing on processing unit 1902, programming modules 1906 may perform processes including, for example, one or more stages of methods, algorithms, systems, applications, servers, databases as described above. The aforementioned process is an example, and processing unit 1902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating preparing plants for regrowing the plants using nutrient film technique, the apparatus comprising:
a conveyor configured for moving at least one plant through a plurality of areas;
a harvesting device disposed in a first area of the plurality of areas, wherein the harvesting device is configured for cutting at least a portion of the at least one plant moved through the first area based on the moving;
a debris removing device disposed in a second area of the plurality of areas, wherein the debris removing device is configured for removing at least one debris attached to the at least one plant moved through the second area after the cutting;
a microbiological control device disposed in a third area of the plurality of areas, wherein the microbiological control device is configured for removing at least one harmful microorganism from the at least one plant moved through the third area after the cleaning; and
a plant additive device disposed in a fourth area of the plurality of areas, wherein the plant additive device is configured for adding at least one plant health additive to the at least one plant moved through the fourth area after the removing.

2. The apparatus of claim 1, wherein the microbiological control device further comprises an irradiating device, wherein the irradiating device is configured for irradiating the at least one plant using at least one germicidal light of at least one germicidal light characteristic, wherein the removing of the at least one harmful microorganism from the at least one plant is further based on the irradiating.

3. The apparatus of claim 2 further comprising:
at least one biological sensor configured for generating at least one biological data based on detecting the at least one harmful microorganism present on the at least one plant; and
a processing device communicatively coupled with the at least one biological sensor, wherein the processing device is configured for:
analyzing the at least one biological data;
determining at least one of a type and a concentration of the at least one harmful microorganism present on the at least one plant based on the analyzing of the at least one biological data;
identifying the at least one germicidal light and the at least one germicidal light characteristic of the at least one germicidal light based on the determining of at least one of the type and the concentration of the at least one harmful microorganism; and
generating at least one second command for the irradiation of the at least one plant based on the identifying, wherein the processing device is communicatively coupled with the irradiating device, wherein the irradiating of the at least one plant using the at least one germicidal light of the at least one germicidal light characteristic is based on the at least one second command.

4. The apparatus of claim 1, wherein the microbiological control device further comprises a microbial agent applicator, wherein the microbial agent applicator is configured for applying at least one microbial control agent to the at least one plant using at least one application method, wherein the removing of the at least one harmful microorganism from the at least one plant is further based on the applying.

5. The apparatus of claim 4 further comprising:
at least one first biological sensor configured for generating at least one first biological data based on detecting the at least one harmful microorganism present on the at least one plant; and
a processing device communicatively coupled with the at least one first biological sensor, wherein the processing device is configured for:
analyzing the at least one first biological data;
determining at least one of a type and a concentration of the at least one harmful microorganism present on the at least one plant based on the analyzing of the at least one biological data;
identifying the at least one microbial control agent and the at least one application method based on the determining of at least one of the type and the concentration of the at least one harmful microorganism; and
generating at least one third command for the applying of the at least one microbial control agent to the at least one plant using the at least one application method based on the identifying, wherein the processing device is communicatively coupled with the microbial agent applicator, wherein the applying of the at least one microbial control agent to the at least one plant using the at least one application method is based on the at least one third command.

6. The apparatus of claim 1 further comprising:
at least one sensor configured for generating at least one sensor data associated with the at least one plant based on detecting at least one plant characteristic of the at least one plant; and
a processing device communicatively coupled with the at least one sensor, wherein the processing device is configured for:
analyzing the at least one sensor data using at least one machine learning model;
identifying at least the portion of the at least one plant based on the analyzing; and
generating at least one command for the cutting of at least the portion of the at least one plant based on the identifying, wherein the harvesting device is communicatively coupled with the processing device, wherein the cutting of at least the portion of the at least one plant is based on the at least one command.

7. The apparatus of claim 1, wherein the debris removing device comprises at least one fluid ejecting device, wherein the at least one fluid ejecting device is configured for ejecting at least one fluid of at least one fluid characteristic on the at least one plant, wherein the removing of the at least one debris attached to the at least one plant is further based on the ejecting.

8. The apparatus of claim 7 further comprising:
at least one first sensor configured for generating at least one first sensor data associated with the at least one plant based on detecting at least one first plant characteristic of the at least one plant; and
a processing device communicatively coupled with the at least one first sensor, wherein the processing device is configured for:
analyzing the at least one first sensor data using at least one first machine learning model;
determining a classification from a plurality of classifications for the at least one plant based on the analyzing of the at least one sensor data;
determining the at least one fluid and the at least one fluid characteristic of the at least one fluid based on the determining of the classification; and
generating at least one first command based on the determining of the at least one fluid and the at least one fluid characteristic, wherein the at least one fluid ejecting device is communicatively coupled with the processing device, wherein the ejecting of the at least one fluid of the at least one fluid characteristic on the at least one plant is based on the at least one first command.

9. The apparatus of claim 1 further comprising:
at least one second sensor configured for generating at least one second sensor data based on detecting at least one second plant characteristic of the at least one plant; and
a processing device communicatively coupled with the at least one second sensor, wherein the processing device is configured for:
analyzing the at least one second sensor data using at least one second machine learning model;
determining a requirement of the at least one plant for the at least one plant health additive based on the analyzing of the at least one second sensor data; and
generating at least one fourth command for the adding of the at least one plant health additive to the at least one plant based on the determining of the requirement, wherein the plant additive device is communicatively coupled with the processing device, wherein the adding of the at least one plant health additive to the at least one plant is based on the at least one fourth command.

10. An apparatus for facilitating preparing plants for regrowing the plants using nutrient film technique, the apparatus comprising:
a conveyor configured for moving at least one plant through a plurality of areas;
a harvesting device disposed in a first area of the plurality of areas, wherein the harvesting device is configured for cutting at least a portion of the at least one plant moved through the first area based on the moving;
a debris removing device disposed in a second area of the plurality of areas, wherein the debris removing device is configured for removing at least one debris attached to the at least one plant moved through the second area after the cutting;
a microbiological control device disposed in a third area of the plurality of areas, wherein the microbiological control device is configured for removing at least one harmful microorganism from the at least one plant moved through the third area after the cleaning, wherein the microbiological control device further comprises an irradiating device, wherein the irradiating device is configured for irradiating the at least one plant using at least one germicidal light of at least one germicidal light characteristic, wherein the removing of the at least one harmful microorganism from the at least one plant is further based on the irradiating; and
a plant additive device disposed in a fourth area of the plurality of areas, wherein the plant additive device is configured for adding at least one plant health additive to the at least one plant moved through the fourth area after the removing.

11. The apparatus of claim 10, wherein the microbiological control device further comprises a microbial agent applicator, wherein the microbial agent applicator is configured for applying at least one microbial control agent to the at least one plant using at least one application method, wherein the removing of the at least one harmful microorganism from the at least one plant is further based on the applying.

12. A method for facilitating preparing plants for regrowing the plants using nutrient film technique, the method comprising:
moving, using a conveyor, at least one plant through a plurality of areas;
cutting, using a harvesting device, at least a portion of the at least one plant moved based on the moving of the at least one plant through a first area of the plurality of areas;
removing, using a debris removing device, at least one debris attached to the at least one plant moved through a second area of the plurality of areas after the cutting;
removing, using a microbiological control device, at least one harmful microorganism from the at least one plant moved through a third area of the plurality of areas after the cleaning; and
adding, using a plant additive device, at least one plant health additive to the at least one plant moved through a fourth area of the plurality of areas after the removing.

13. The method of claim 12, wherein the microbiological control device further comprises an irradiating device, wherein the irradiating device is configured for irradiating the at least one plant using at least one germicidal light of at least one germicidal light characteristic, wherein the removing of the at least one harmful microorganism from the at least one plant is further based on the irradiating.

14. The method of claim 13 further comprising:
generating, using at least one biological sensor, at least one biological data based on detecting the at least one harmful microorganism present on the at least one plant;
analyzing, using a processing device, the at least one biological data;
determining, using the processing device, at least one of a type and a concentration of the at least one harmful microorganism present on the at least one plant based on the analyzing of the at least one biological data;
identifying, using the processing device, the at least one germicidal light and the at least one germicidal light characteristic of the at least one germicidal light based on the determining of at least one of the type and the concentration of the at least one harmful microorganism; and
generating, using the processing device, at least one second command for the irradiation of the at least one plant based on the identifying, wherein the processing device is communicatively coupled with the irradiating device, wherein the irradiating of the at least one plant using the at least one germicidal light of the at least one germicidal light characteristic is based on the at least one second command.

15. The method of claim 12, wherein the microbiological control device further comprises a microbial agent applicator, wherein the microbial agent applicator is configured for applying at least one microbial control agent to the at least one plant using at least one application method, wherein the removing of the at least one harmful microorganism from the at least one plant is further based on the applying.

16. The method of claim 15 further comprising:
generating, using at least one first biological sensor, at least one first biological data based on detecting the at least one harmful microorganism present on the at least one plant;
analyzing, using a processing device, the at least one first biological data;
determining, using the processing device, at least one of a type and a concentration of the at least one harmful microorganism present on the at least one plant based on the analyzing of the at least one biological data;
identifying, using the processing device, the at least one microbial control agent and the at least one application method based on the determining of at least one of the type and the concentration of the at least one harmful microorganism; and
generating, using the processing device, at least one third command for the applying of the at least one microbial control agent to the at least one plant using the at least one application method based on the identifying, wherein the processing device is communicatively coupled with the microbial agent applicator, wherein the applying of the at least one microbial control agent to the at least one plant using the at least one application method is based on the at least one third command.

17. The method of claim 12 further comprising:
generating, using at least one sensor, at least one sensor data associated with the at least one plant based on detecting at least one plant characteristic of the at least one plant;
analyzing, using a processing device, the at least one sensor data using at least one machine learning model;
identifying, using the processing device, at least the portion of the at least one plant based on the analyzing; and
generating, using the processing device, at least one command for the cutting of at least the portion of the at least one plant based on the identifying, wherein the harvesting device is communicatively coupled with the processing device, wherein the cutting of at least the portion of the at least one plant is based on the at least one command.

18. The method of claim 12, wherein the debris removing device comprises at least one fluid ejecting device, wherein the at least one fluid ejecting device is configured for ejecting at least one fluid of at least one fluid characteristic on the at least one plant, wherein the removing of the at least one debris attached to the at least one plant is further based on the ejecting.

19. The method of claim 18 further comprising:
generating, using at least one first sensor, at least one first sensor data associated with the at least one plant based on detecting at least one first plant characteristic of the at least one plant;
analyzing, using a processing device, the at least one first sensor data using at least one first machine learning model;
determining, using the processing device, a classification from a plurality of classifications for the at least one plant based on the analyzing of the at least one sensor data;
determining, using the processing device, the at least one fluid and the at least one fluid characteristic of the at least one fluid based on the determining of the classification; and
generating, using the processing device, at least one first command based on the determining of the at least one fluid and the at least one fluid characteristic, wherein the at least one fluid ejecting device is communicatively coupled with the processing device, wherein the ejecting of the at least one fluid of the at least one fluid characteristic on the at least one plant is based on the at least one first command.

20. The method of claim 12 further comprising:
generating, using at least one second sensor, at least one second sensor data based on detecting at least one second plant characteristic of the at least one plant;
analyzing, using a processing device, the at least one second sensor data using at least one second machine learning model;
determining, using the processing device, a requirement of the at least one plant for the at least one plant health additive based on the analyzing of the at least one second sensor data; and
generating, using the processing device, at least one fourth command for the adding of the at least one plant health additive to the at least one plant based on the determining of the requirement, wherein the plant additive device is communicatively coupled with the processing device, wherein the adding of the at least one plant health additive to the at least one plant is based on the at least one fourth command.
